(19) United States
(12) Patent Application Publication
(10) Pub. No.: US 2026/0365263 A1
(43) Pub. Date: Nov. 19, 2026

(54) TRACK SYSTEM FOR OFF-ROAD VEHICLES, INCLUDING ZERO TURN LAWN MOWERS

(71) Applicant: Grass Pros Outdoors LLC, Big Sandy, TX (US)

(72) Inventor: Kevin Honeycutt, Big Sandy, TX (US)

(21) Appl. No.: 19/210,288

(22) Filed: May 16, 2025

(51) Int. Cl. B62D 55/24; A01D 34/00; B62D 55/108; B62D 55/125; B62D 55/30; A01D 101/00

(52) U.S. Cl. CPC B62D 55/24; A01D 34/00; B62D 55/1083; B62D 55/125; B62D 55/305; A01D 2101/00

(57) ABSTRACT

A track system for attachment and use with off-road vehicles, such as consumer grade zero turn lawn mowers, is provided for attachment to the vehicle using existing frame and drive system elements (e.g., drive axles and motors for rotating them) of most off-road vehicles, without significant modification. The track system provides improved traction and stability during operation on varied and unpredictable terrain. The track system includes a traveling sub-frame disposed between right and left rear track assemblies. Each track assembly is mounted to a respective drive axle of the vehicle. Each track assembly includes a single drive sprocket and a single rear facing idler / tensioner roller, around which is disposed a continuous track for engaging the ground. The track system also includes a suspension torsion assembly for applying and removing tension to the single idler / tensioner roller of each track assembly.

### FIELD OF THE INVENTION

The present disclosure relates generally to track assemblies configured for attachment to and operation with off-road vehicles to provide improved traction and stability during their use. More particularly, the present disclosure relates to track assemblies which replace rear ground-engaging wheels of off-road vehicles such as, but without limitation, zero turn lawn mowers, and provide improved traction and stability while operating on unpaved and varied terrain.

### BACKGROUND

Wheeled off-road vehicles include 3- and 4-wheeled recreational, construction, and agricultural vehicles and equipment such as all-terrain vehicles (ATVs), snowmobiles, backhoes, loaders, tractors, lawn mowers, and many others. It has long been known that such wheeled off-road vehicles sometimes lack sufficient traction to ensure continued and controlled movement on unpaved, unpredictable, and varied terrain. For many off-road vehicles, this problem has been addressed by substituting one or both pairs of front and rear wheels of off-road vehicles with pairs of track assemblies. Some off-road vehicles which have a single front wheel or a single rear wheel have, instead, been modified for improved traction by replacing that single wheel with a single track assembly, with or without also replacing the pair of wheels at the opposite end of the vehicle with a pair of track assemblies.

Generally, a track assembly has a continuous (or endless) track wrapped around a plurality of wheels, at least one of which is a sprocket with which the track assembly is operatively mounted onto a respective drive axle of the off-road vehicle, in substitution of a ground-engaging wheel. The continuous track of each track assembly contacts the ground and provides improved traction to the off-road vehicle during use. Currently, many off-road vehicles are manufactured and provided already having one or more track assemblies, while others are modified after manufacture by removing one or more factory installed wheels and replacing them with track assemblies. Track assemblies may be designed and configured to fit and function with particular types and models of off-road vehicles, or with categories of off-road vehicles having at least partially standardized components and dimensions.

While such track assemblies have successfully provided better and more reliable off-road traction, for commercial and professional scale working off-road vehicles such as tractors, lawn mowers, etc., they have most often been designed for use on commercial or professional scale vehicles, which tend to be larger and of more durable design and construction than smaller consumer scale off-road vehicles and equipment. Furthermore, some scaled down track assemblies and systems have been designed and configured for use on consumer grade recreational vehicles, including ATVs and snowmobiles.

However, scaling down and configuring track assemblies for effective use with smaller consumer scale off-road vehicles such as lawn mowers has turned out not to be a simple or easy endeavor. Consequently, existing track assemblies developed to date for use on commercial or professional scale lawn mowers, even zero turn lawn mowers, are not scalable or readily adaptable to fit and function with consumer scale lawn mowers because they are generally too large and require too many components for proper operation with the smaller consumer scale lawn mowers.

The foregoing issues are addressed and resolve by the track systems and track assemblies disclosed and contemplated herein which have been designed and configured to mount on and operate with consumer scale lawn mowers, thereby providing increased traction, efficacy and stability to consumer scale lawn mowers.

### SUMMARY OF THE INVENTION

A track system is provided for attachment and use with an off-road vehicle and which provides increased traction with terrain on which the vehicle is operated, wherein the vehicle has a vehicle frame, a right rear drive axle, and left rear drive axle, the track system comprising: a right rear track assembly and a left rear track assembly, each comprising: a single drive sprocket, a single idler / tensioner roller which is positioned at the rear of and being in contact with its corresponding drive sprocket, a continuous track which is disposed around and in contact with both of the corresponding single drive sprocket and the corresponding single idler / tensioner roller, wherein the drive sprocket of the right rear track assembly is configured for rotatably mounting to the right rear drive axle of the vehicle and moves the continuous track of the right rear track assembly when rotated by operation of the right rear drive axle, and the drive sprocket of the left rear track assembly is configured for rotatably mounting to the left rear drive axle of the vehicle and moves the continuous track of the left rear track assembly when rotated by operation of the left rear drive axle.

The track assembly further comprises a suspension frame assembly configured to allow limited movement of the track assembly relative to the vehicle frame and provide torsion adjustments to each of the single idler / tensioner rollers of the right and left rear track assemblies, the suspension frame assembly comprising: a main frame having a right side and a left side and configured to affix the track system to the mower frame, and a traveling sub-frame which is configured to be movably affixed to the main frame and capable of limited forward and backward reciprocal movement relative to the main frame and the vehicle frame; a right torsion axle assembly movably affixed to the traveling sub-frame, at a right side thereof, and capable of limited right and left reciprocal movement relative to the traveling sub-frame, and operably connected to the idler / tensioner roller of the right rear track assembly for applying and releasing torsion on the idler / tensioner roller and on the continuous track of the right rear track assembly during operation of the vehicle, and a left torsion axle assembly movably affixed to the traveling sub-frame, at a left side thereof, and capable of limited right and left reciprocal movement relative to the traveling sub-frame, and operably connected to the idler / tensioner roller of the left track assembly for applying and releasing torsion on the idler / tensioner roller and on the left rear track assembly during operation of the vehicle.

In some embodiments, the traveling sub-frame comprises: a right traveling sub-frame unit moveably affixed to a right side of the main frame and the right torsion axle assembly being movably affixed thereto, and a left traveling sub-frame unit moveably affixed to a left side of the main frame and the left torsion axle assembly being movably affixed thereto.

In some embodiments, each of the right torsion axle assembly and the left torsion axle assembly includes a swing arm and a torsion box pivotably connected to the swing arm and having two or more left to right oriented slotted holes, wherein the right torsion axle assembly is movably attached by its torsion box to a right side of the traveling sub-frame using the two or more left to right oriented slotted holes, and the left torsion axle assembly is movably attached by its torsion box to a left side of the traveling sub-frame using the two or more left to right oriented slotted holes.

In some embodiments, wherein the traveling sub-frame is movably affixed to the main frame and capable of limited frontward and backward movement by at least a first movable connection and a second movable connection, wherein the first movable connection is formed by two or more front to rear oriented slotted holes provided on the right side of the main frame and two or more non-slotted holes provided on the right side of the traveling sub-frame, wherein each of the slotted holes is aligned with a corresponding one of the two or more non-slotted holes on the right side of the traveling sub-frame unit and has a respective bolt inserted therethrough and secured with a nut, and the second movable connection is formed by two or more front to rear oriented slotted holes provided on the left side of the main frame and two or more non-slotted holes provided on the left side of the traveling sub-frame unit, wherein each of the slotted holes is aligned with a corresponding one of the two or more non-slotted holes on the left side of the traveling sub-frame unit and has a respective bolt inserted therethrough and secured with a nut.

The track system of Claim 1, wherein the main frame and the traveling sub-frame of the suspension assembly are movably affixed to the vehicle frame and wherein the main frame and the traveling sub-frame are capable of limited front to rear movement together, relative to the vehicle frame.

A vehicle is also provided which includes the foregoing track system or has it mounted thereon. In some embodiments, the vehicle is a zero-turn lawn mower. Further, the zero-turn lawn mower may be a consumer scale zero-turn lawn mower.

In some embodiments, the vehicle which includes the foregoing track system or has it mounted thereon is an all-terrain vehicle (ATV). In some embodiments, the vehicle which includes the foregoing track system or has it mounted thereon is a snowmobile and comprises at least one ski operably mounted to a front part of the snowmobile.

### BRIEF DESCRIPTION OF THE FIGURES

The present invention will be further explained with reference to the attached drawings, wherein like structures are referred to by like numerals and/or letters throughout the several views. The drawings shown are not necessarily to scale, with emphasis instead generally being placed upon illustrating the principles of the present invention.

FIG. 1 is a perspective top, front, left side view of a zero turn lawn mower having an exemplary embodiment of the track system installed thereon, in which the left rear track assembly of the track system is visible;

FIG. 2 is an elevational rear plan view of the zero turn lawn mower of FIG. 1, providing a more complete rear view of the track system installed thereon and in which both the right and left track assemblies of the track system are visible;

FIG. 3 is a perspective top, rear, right side view of the zero turn lawn mower having the track system installed thereon as in FIG. 1, in which the right rear track assembly is visible and the left rear track assembly is partially visible;

FIG. 4 is an elevational right side view of the zero turn lawn mower having the track system installed thereon as in FIG. 1, in which the right rear track assembly is visible;

FIG. 5 is a perspective top, rear, right side view of the left rear track assembly of the track system of FIGS. 1-3, shown independently and prior to attachment to the mower;

FIG. 6 is an enlarged partial perspective view of the right rear track assembly of FIG. 4, showing the idler roller engaged with drive sprocket;

FIG. 7 is an enlarged partial perspective rear, left side view of the right rear track assembly and its orientation and connections to the associated suspension axle and travel subframe of the track system;

FIG. 8 is a further enlarged partial perspective view, taken from FIG. 7, showing the right rear track assembly and associated suspension axle and travel subframe connected thereto;

FIG. 9 is a further enlarged cut out view of the features within the dotted window J provided on FIG, 8, showing a portion of the assembled right side of the track system which includes the jack bolt;

FIG. 10 is a schematic cross-sectional view of the features shown in FIG. 9, taken along line A-A and looking in the direction of the arrows, showing the positioning of the jack bolt; and

FIG. 11 is an enlarged rear, top-down angled, view of a portion of the main frame, sub-frame and right rear track assembly, showing the right clamp bracket of the track system with which the sub-frame of the track system is securely attached to mower frame.

### DETAILED DESCRIPTION

Detailed embodiments of the track system are disclosed herein. It should be understood that the disclosed embodiments are merely illustrative of the track system described and contemplated herein, which may be embodied in various forms. In addition, each of any examples provided in connection with the various embodiments of the track system described and contemplated herein is intended to be illustrative, and not restrictive.

Further, any figures provided are not necessarily to scale, and some features may be exaggerated to show details of particular components or features. In addition, any measurements, specifications and the like shown in any figures are intended to be illustrative, and not restrictive. Therefore, specific structural and functional details disclosed herein are not to be interpreted as limiting, but merely as examples for teaching one skilled in the art to variously employ the subject matter described and contemplated herein.

Unless otherwise explicitly stated hereinbelow, pronouns in the singular, such as “a” and “the,” are not intended to be limited to meaning that only one of the features, compositions, or method steps being described is present or performed. Rather, use of such pronouns with features, compositions, or method steps, being described means that “at least one” or “one or more” such feature, composition, or method step is present or performed.

Relative positional terms such as, but not limited to, right, left, front, rear, forward, and backward, as used herein, should be interpreted from the point of view of a user occupying the lawn mower or other off-road vehicle (M), while sitting in or standing near the seat typically provided in such mowers and other off-road vehicles. When these relative terms are used to describe features and aspects of the track system when not yet mounted on a lawn mower or other off-road vehicle, they should be interpreted as if the track system has been mounted on a lawn mower or other off-road vehicle.

The track system disclosed and contemplated herein is configured for installation and use with outdoor off-road vehicles typically driven and used on unimproved terrain, gravel and dirt paths, and other unpaved surfaces and varied terrain, for providing greater traction and stability to such vehicles. Generally, the track system described and contemplated herein is designed for attachment and use with any off-road vehicle which includes at least a vehicle frame, a right rear drive axle, a left rear drive axle, and a power source for driving each of the aforesaid drive axles. Accordingly, it should be understood that the track system is suitable for use with, and will provide improved traction and stability for, any of several types of off-road vehicles including, but not limited to, recreational, construction, and agricultural vehicles and equipment, such as, without limitation, all-terrain vehicles (ATVs), snowmobiles, backhoes, loaders, tractors, lawn mowers, and many others.

While exemplary embodiments of the track system described below have a simplified design, with fewer components and configured to replace the rear wheels of consumer grade zero turn lawn mowers for providing increased traction and stability, they are not limited to such embodiments and applications. Rather, the track system described herein may be modified to have alternative configurations and components which enable its attachment and use with other types of lawn mowers, as well as other types of off-road vehicles such as, but not limited to, personal recreational off-road vehicles. Modified embodiments of the track system may also, for example, be configured to replace wheels other than, or in addition to, rear wheels of off-road vehicles.

Furthermore, it is contemplated that the track system may, based on the present disclosure and the ability of skilled artisans, be modified and configured for attachment and operation with relatively small or light versions of commercial or professional grade off-road vehicles to provide improved traction and stability thereto, and at a reduced cost compared to existing more complicated track systems.

While track assemblies have been developed and used for commercial and professional grade off-road vehicles they tend not to be readily adaptable for use with consumer grade off-road vehicles. Commercial and professional grade off-road vehicles are, generally speaking, more durable and powerful, being assembled using heavier and larger components made from stronger and more durable materials, as well as often having more powerful engines and motors, and being engineered with components capable of greater speeds, higher revolutions, higher weight-bearing and suspension capabilities. The foregoing factors typically result in track systems and assemblies for commercial and professional grade off-road vehicles being larger, more complicated, and involving a greater number of components.

Although consumer grade off-road vehicles lack many of the foregoing characteristics relating to higher speeds, more power, and greater durability, they are nonetheless designed for and readily capable of performing the types and frequencies of tasks and projects typically engaged in by consumers. However, when equipped with only wheels for mobility, consumer grade off-road vehicles also tend to encounter traction and stability issues when operated on unimproved and varied terrain. Compared to larger and more complex track systems typically designed for commercial and professional grade off-road vehicles, the presently described track system has been simplified to have fewer components yet provide all necessary functionalities required to operate and provide improved traction to consumer grade off-road vehicles such as, but not limited to, consumer grade zero-turn lawn mowers.

In any of its several exemplary and other embodiments, the components of the track system are generally configured (sized and shaped) to enable attachment and use of the track system with the existing drive system elements (e.g., drive axles) and frame of the vast majority of existing consumer grade zero turn lawn mowers without significant modification. It is expected that the track system described and contemplated herein will be easily bolted onto the factory designed frame and existing components of consumer grade zero turn lawn mowers. Furthermore, the track systems described herein are easily adapted for attachment to and operation with most standard zero-turn lawn mowers of different makes and models, as will be described later in further detail. In addition, modifications to the track system will be easily made by persons of ordinary skill in the relevant art, based on the present disclosure, to successfully adapt the track system to be attached and used with most standardized makes and models of off-road vehicles of any particular class and type.

The following description is an exemplary embodiment of the track system which is configured for attachment and use with a zero turn lawn mower and provides improved traction and stability, thereby minimizing or preventing loss of control and mobility of the mower during operation on varied and unpredictable terrain.

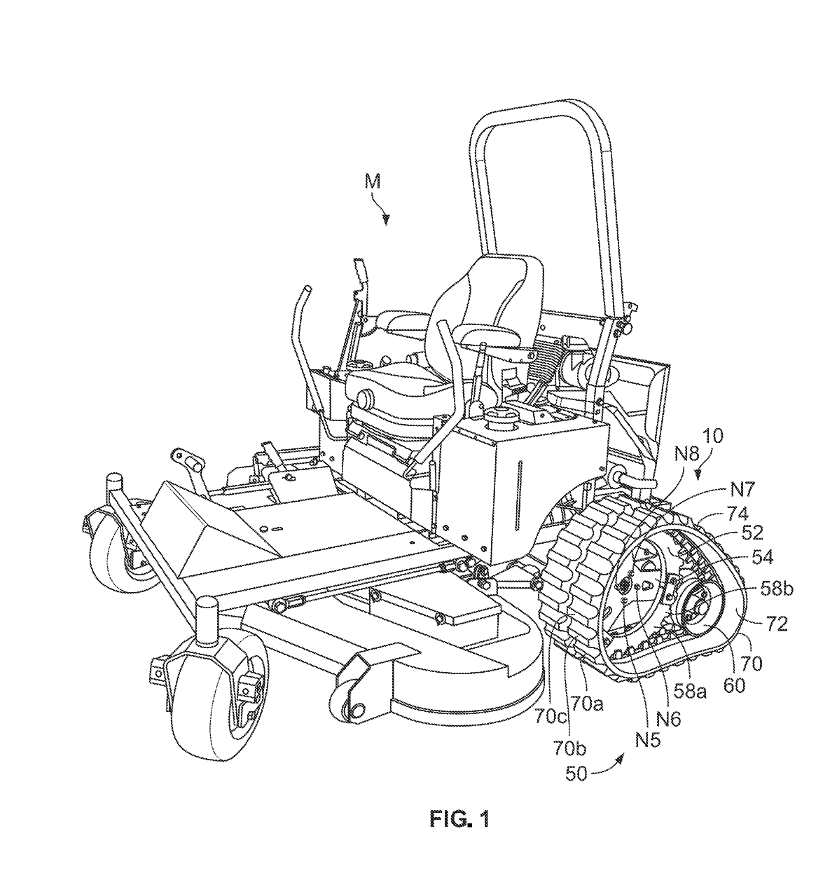

With reference initially to FIGS. 1-4, a zero turn lawn mower (M) is shown having the track system 10 operably attached thereto in a manner described in more detail later. The zero-turn lawn mower includes at least a mower frame (F), a right rear drive axle, a left rear drive axle (not shown per se, but standard on most off-road vehicles), and at least one motor and power source (not shown per se in the figures) for driving each of the aforesaid drive axles. Although not shown, as is also standard on most off-road vehicles, each of the right and left rear drive axles of the mower (M) includes a respective hub having a plurality of wheel studs used for mounting a wheel (or other ground-engaging device) to each drive axle, using a corresponding plurality of lug nuts.

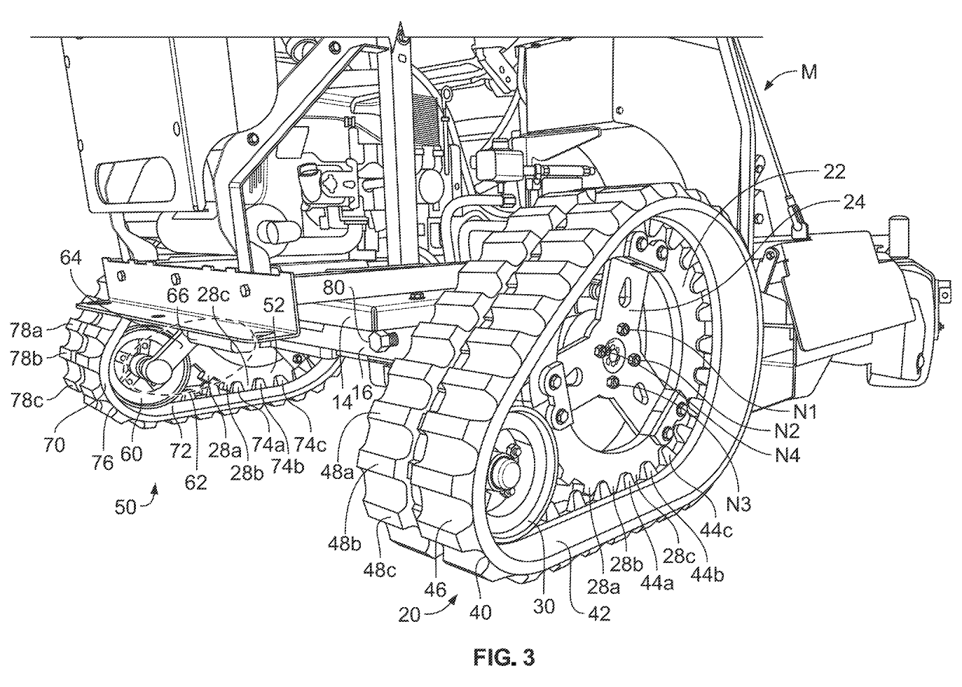

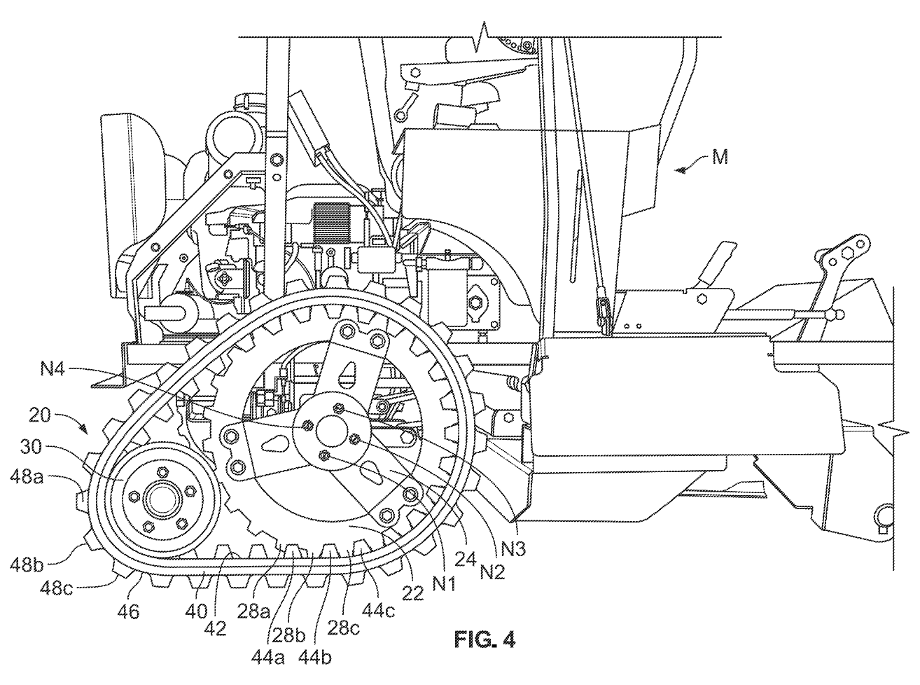

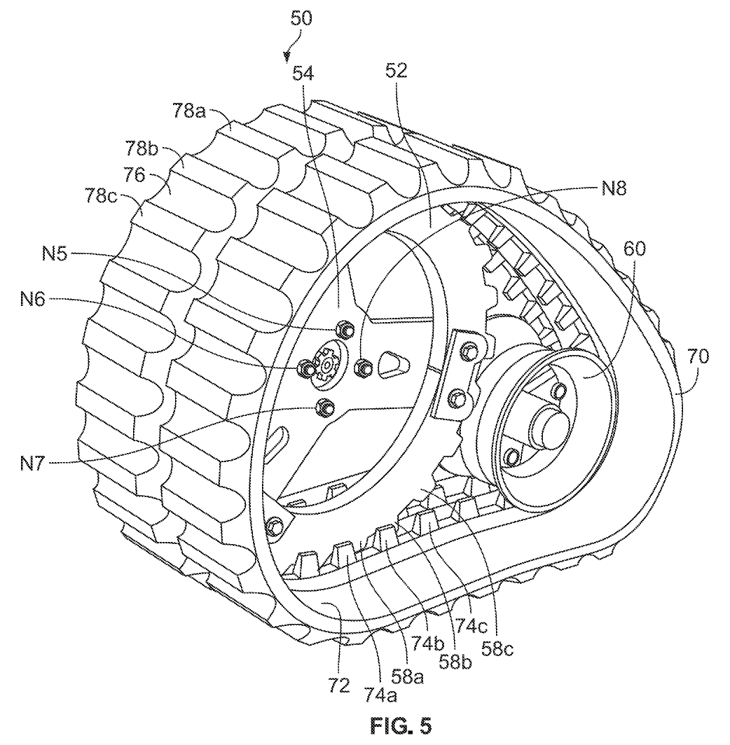

Although the wheel studs of the rear drive axles of the mower (M) are not independently visible in the figures, they are standard features. In FIGS. 3 and 4, the right side lug nuts N1, N2, N3, N4 used to mount the right track assembly 20 to the right rear drive axle of the mower are visible and indicate the approximate locations of the wheel studs on the right rear drive axle. Similarly, the left side lug nuts N5, N6, N7, N8, which are used to mount the left track assembly 50 to the left rear drive axle of the mower, are visible in FIG. 5 and indicate the approximate locations of the wheel studs on the left rear drive axle.. It should be further understood that the types of motor(s) and power source(s) of the mower (M) are not particularly limited and may, for example without limitation, comprise devices such as an internal combustion engine and drive train, one or more electric motors, or a combination thereof.

The track system 10 is configured and dimensioned to provide the rear ground-engaging elements of the mower (M), which may either be manufactured and assembled having the track system 10 installed on the mower (M) instead of rear wheels, or manufactured having rear wheels which are subsequently removed and replaced by the track system 10. As will be explained below, the track system 10 is configured for attachment to and operation with most standard zero-turn lawn mowers of different makes and models, with simple modifications made mainly to dimensions and configurations of some components, locations of bolt holes on some components, and the like, to properly align, connect, and cooperate with the features of different makes and models of mowers such as, but not limited to, frames, drive axles, wheels, etc. Additionally, components of the track system 10 may be further easily modified to fit and function with nonstandard zero-turn lawn mowers having differently configured or dimensioned frames, drive axles, etc., as will be described later in further detail.

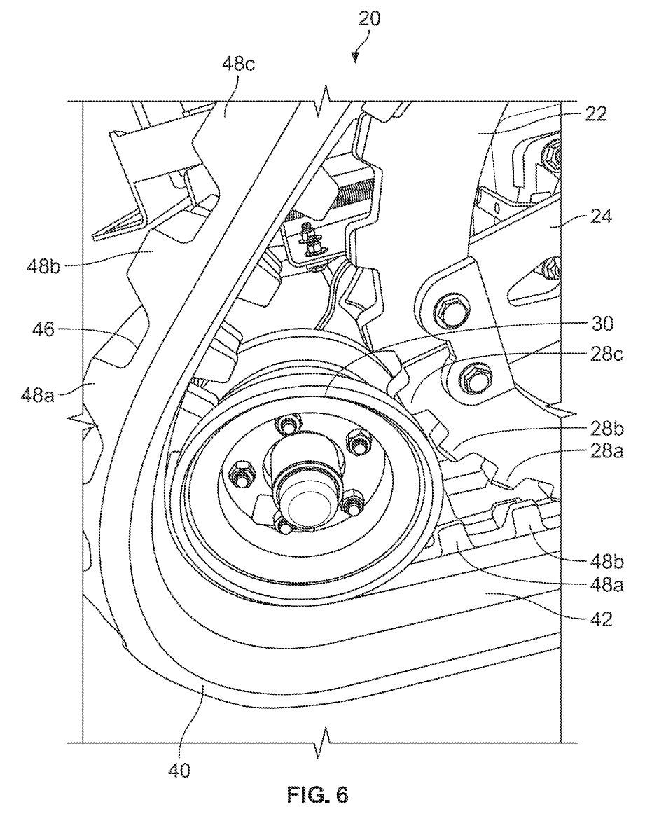

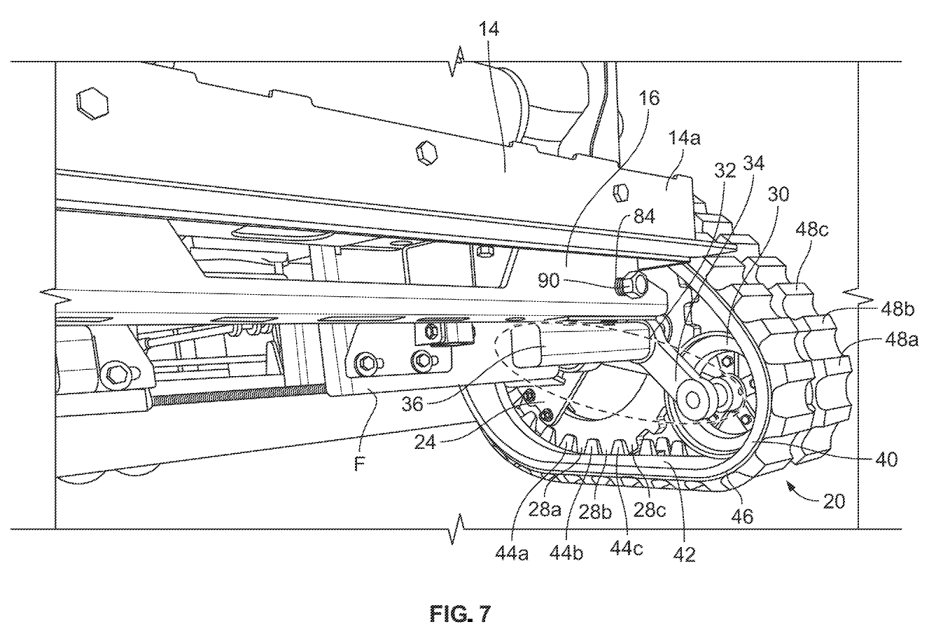

As shown generally in FIGS. 1-8, an exemplary embodiment of the track system 10 comprises a suspension frame assembly which attaches the track system 10 securely to the mower frame (F) and is configured to allow limited movement of the track assembly 10 and provide torsion adjustments, as described in detail below. The track system 10 further comprises a right rear track assembly 20 which is configured for attachment to the right side of the suspension frame assembly and to the right rear drive axle of the mower (M), and a left rear track assembly 50 which is configured for attachment to the left side of the suspension frame assembly and to the left rear drive axle of the mower (M).

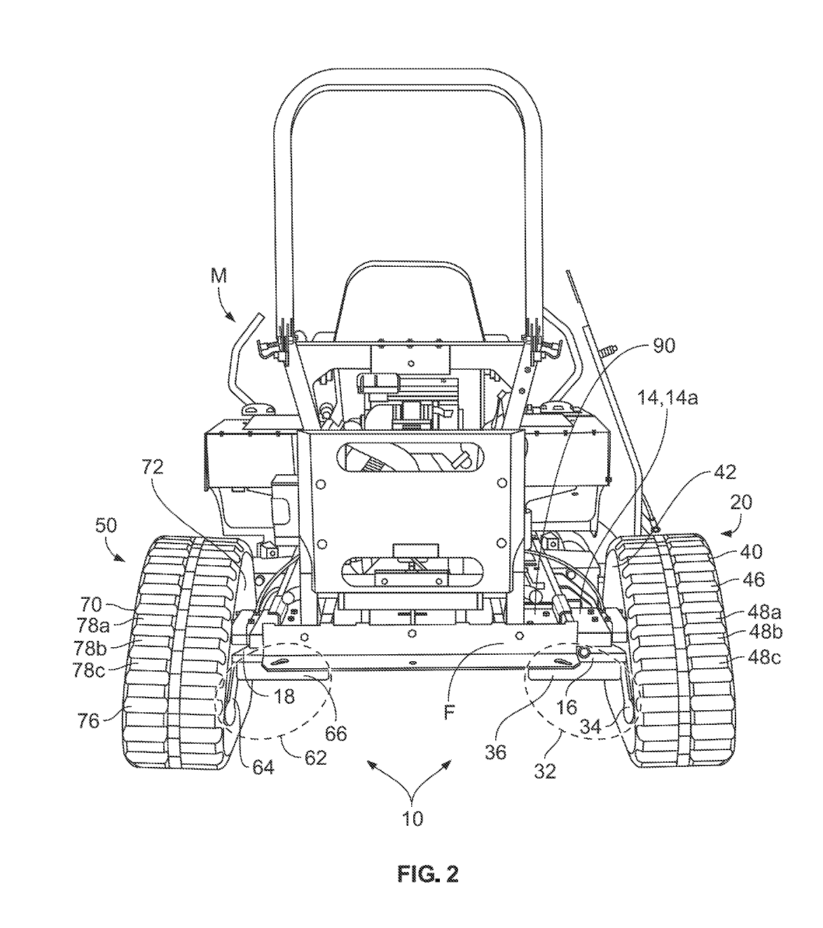

More particularly, as can be seen in FIGS. 2-3 and 7-8, the suspension frame assembly includes a main frame 14 configured to affix the track system 10 to the mower frame (F), and a traveling sub-frame 16, 18 which is movably affixed to the main frame 14. The traveling sub-frame 16, 18, whether present in a single unit or multiple independent units 16, 18 as in the presently described exemplary embodiment, is configured for attachment to the main frame 14 and allows limited forward and backward reciprocal movement of the track system 10 relative to the main frame 14 and the mower frame (F).

It is noted that the main frame 14 is a component present in all embodiments of the track system 10 and provides the same general functions, as described above and in additional detail later. Nonetheless, modifications to the shape and dimensions (e.g., configuration, thickness, length, etc.) of the main frame 14 are expected and well within the ability of persons of ordinary skill in the relevant art, as needed to adapt the track system 10 for attachment and use with differently configured mower frames (F) of various makes and models zero turn lawn mowers. It should be noted that, although the main frame 14 is shown and described herein as being a single unitary component which extends across the width of the mower (M) (see especially FIG. 2), the main frame 14 may comprise two or more individual sub-components for independent or indirect attachment at the rear of the mower (M), at its right and left sides.

Furthermore, it is noted that the traveling sub-frame 16, 18 is another component present in all embodiments of the track system 10 and provides the same general functions, as described above and in additional detail later, whether provided as a single assembly extending across the width of the mower (M), or including a right traveling sub-frame unit 16 and a left traveling sub-frame unit 18 (See FIG. 2), as in the embodiment described here. Modifications to the shape and dimensions (e.g., configuration, thickness, length, etc.) of the traveling sub-frame 16, 18 are also expected and well within the ability of persons of ordinary skill in the relevant art, as needed to adapt the track system 10 for attachment and use with differently configured mower frames (F) of various makes and models zero turn lawn mowers.

Returning to the exemplary embodiment shown in FIGS. 2, 7 and 8, the traveling sub-frame 16, 18 may include a right traveling sub-frame unit 16 and a left traveling sub-frame unit 18 (see FIG. 2), which are mirror images of one another. Each of the right and left traveling sub-frame units 16, 18 is movably affixed to the main frame 14, at right and left ends thereof 14a, 14b, respectively, and allows limited forward and backward reciprocal movement of the right and left traveling sub-frame units 16, 18 and the track system 10 relative to the mower (M) and its mower frame (F), which assists in applying and releasing torsion to each of the right and left track assemblies 20, 50.

The suspension frame assembly also includes right and left torsion axle assemblies 32, 62, which are mirror images of one another and both include a swing arm 34, 64 and a torsion box 36, 66, respectively. Generally, each of the right and left torsion axle assemblies 32, 62 is affixed to a corresponding one of the right and left traveling sub-frame units 16, 18 (or to right and left sides of a unitary traveling sub-frame), as well as to a corresponding one of the right and left track assemblies 20, 50, for applying and releasing torsion on the right and left track assemblies 20, 50, respectively, during operation.

More specifically, in the exemplary embodiment described herein, and as best viewed in FIGS. 2, 7 and 8, the swing arm 34 of the right torsion axle assembly 32 is attached to the torsion box 36 of the right torsion axle assembly 32 as well as to the right track assembly 20, in a manner described in more detail later. Furthermore, the right torsion axle assembly 32 is attached by its torsion box 36 to the right traveling sub-frame unit 16 in a manner which allows limited right and left reciprocal movement relative to the right traveling sub-frame unit 16 and the main frame 14.

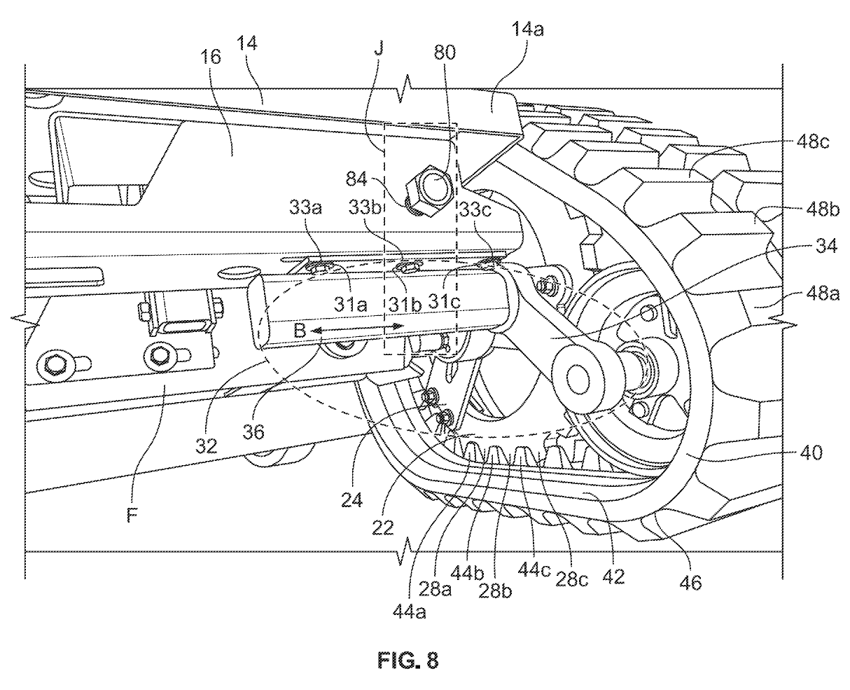

As shown in FIG. 8, the torsion box 36 includes a plurality of elongated or slotted holes 31a, 31b, 31c, oriented right-to-left, for receiving bolts 33a, 33b, 33c, therethough. The bolts 33a, 33b, 33c further extend through a corresponding number of holes (not visible in the figures and not slotted) which are provided in an underside of the right traveling sub-frame 16 and are aligned with the slotted holes 31a, 31b, 31c. In the foregoing configuration, the right torsion axle assembly 32 is attached the right traveling sub-frame unit 16 and allowed limited right and left reciprocal movement relative to the right traveling sub-frame unit 16.

Since the right and left torsion axle assemblies 32, 62 are mirror images and operate in the same manner. Accordingly, the foregoing explanation of the components of the right torsion axle assembly 32, as well as how it is connected to the right traveling sub-frame unit 16 and right track assembly 20, applies equally to the left torsion axle assembly 62 and will not be repeated for the left torsion axle assembly 62.

Turning now to the track assemblies 20, 50, FIGS. 1 and 3 provide front-left and rear-right perspective views, respectively, of the mower (M) with the track system 10 attached thereto. The left rear track assembly 20 of the track system 10 is visible in FIG. 1, while FIG. 3 shows the right rear track assembly 20 and a portion of left rear track assembly 50 of the track system 10. The rear view of FIG. 2 shows both of the right and left rear track assemblies 20, 50 and overall the orientation and position of the track system 10 when operably attached to the mower (M). Finally, FIG. 4 provides a side view of the right rear track assembly 20 attached to the mower (M), and FIG. 5 provides a front-left perspective view of the left rear track assembly 50 separate from the mower (M).

As will be apparent from the several views provided in FIGS. 1-5 and the following description, the right rear track assembly 20 and the left rear track assembly 50 have analogous components which are arranged and assembled so that the right and left rear track assemblies 20, 50 are mirror images of one another. More particularly, each of the right rear track assembly 20 and left rear track assembly 50 includes a single drive sprocket 22, 52 and a single rearward facing idler / tensioner roller 30, 60 which is in tangential contact with its corresponding drive sprocket 22, 52 (see FIGS. 1 and 4-6).

Currently known track assemblies generally include more than one (i.e., two or more) idler / tensioner rollers, often having at least one such roller positioned both in front of and at the rear of the drive sprocket (not shown in the figures), though some versions of known track assemblies include two such idler / tensioner rollers positioned either at the rear of the drive sprocket, and one or more such rollers positioned in front of the drive sprocket. Such track assemblies are, for example, disclosed in U.S. Patent No. 9,211,921, for use with all-terrain vehicles (ATVs) and snowmobiles. Notably, ATVs and snowmobiles do not have the cutting blade and shield apparatus underneath the vehicle and between the front and rear ground-contacting wheels of consumer zero-turn lawn mowers that would obstruct and prevent use of the track assemblies disclosed therein with such lawn mowers. Particularly when the off-road vehicle is zero-turn lawn mower having a cutting deck situated under the mower frame and in front of one or both rear tires, the distance between the rear of that cutting deck and mower’s drive axles to not large enough for insertion of the type of track assembly described above which as one or more idler tensioner rollers positioned in front of the drive sprocket.

Moreover, since the aforesaid conventionally used track systems have at least two idler / tensioner rollers (i.e., at least one in front and at least one at the rear of the drive sprocket), off-road vehicles having a pair of such track systems installed on their rear axles generally incur significantly more expense and time when maintaining and replacing components of the aforesaid existing track systems to address wear and tear caused not only be simple operation, but also due to water, dirt and debris typically encountered and collecting among the track system’s components.

On the other hand, larger heavy duty track assemblies have been developed having a drive sprocket and a single idler / tensioner roller, they are designed to replace the entire front, rear, or both front and rear, single axle drive assemblies. For example, U.S. Patent No. 10,150,523 discloses an off highway vehicle, such as an agricultural tractor or other equipment, having a single axle rear chassis having a single rear axle shaft and housing, to which the aforesaid right and left rear track assemblies are mounted and operable. Since these track assemblies include single axle drive systems, as well as heavier more complex multi-component drive sprockets, they are not suitable or adaptable for installation and use with consumer zero-turn law mowers which have independent right and left rear drive axles and obstructing cutting blade and shield apparatus underneath the mower and between the front and rear ground-engaging elements (wheels/tracks).

In contrast, all embodiments of the track assemblies 20, 50 of the presently disclosed track system 10 include a single (i.e., only one) drive sprocket 22, 52 and a single (i.e., only one) idler / tensioner roller 30, 60, and each of the idler / tensioner rollers 30, 60 is always rear facing relative to (i.e., positioned at the rear of) the single drive sprocket 22, 52, respectively. This simplified and smaller sized, yet functional and effective, design of the right and left rear track assemblies 20, 50 differentiates the present track assemblies 20, 50 and track systems 10 including them, from known track assemblies and systems.

As explained in further detail below, the single drive sprocket 22, 52 of each of the right and left rear track assemblies 20, 50, respectively, is affixed to a respective one of the right and left rear drive axles of the mower (M) for imparting rotational movement to the drive sprockets 22, 52. Consequently, when the right and left rear drive axles are rotated, each of the corresponding continuous tracks 40, 70 (describe in more detail later) of each of the right and left rear track assemblies 20, 50 are also rotated.

While drive sprockets 22, 52 having a diameter of approximately 24 inches will enable the attachment and use of the track system 10 with most currently known makes and models of zero turn lawn mowers (M), this dimension may be easily adjusted, such as increased or decreased by approximately 1-2 inches, to match the dimensions of other (less standardized) makes and models of zero-turn lawn mowers. Accordingly, it should be understood that persons of ordinary skill in the relevant art will be readily able to configure the track system 10 to attach and function with various zero turn lawn mowers (M) by selecting a suitable diameter for both of the drive sprockets 22, 52 of each of the right and left rear track assemblies 20, 50, respectively, where the suitable diameter is currently expected to be from about 22 inches to about 26 inches, but is subject to change and yet still determinable by such persons of ordinary skill.

The selected diameter should be approximately the same (i.e., within +/- 0.5 inch) for both of the drive sprockets 22, 52 of a given track system 10. Additionally, although permissible and not prohibited, it is not generally necessary to modify the diameter of the corresponding idler / tensioner roller 30, 60 according to changes in the diameter of the drive sprockets 22, 52. Within a given track system 10, the diameters of the right and left idler / tensioner rollers 30, 60 should be approximately the same (i.e., within +/- 0.5 inch),with suitable diameters being from about 8 in. to about 9 inches, such as about 8.5 in., as is readily determinable by persons of ordinary skill in the relevant art.

Each drive sprocket 22, 52 has a sprocket hub 24, 54, each of which has a plurality of openings (not visible) for receiving therethrough corresponding wheel studs and which, therefore, correspond in alignment and number with the wheel studs provided on the right and left drive axles of the mower (M). Accordingly, for example, the above-mentioned lug nuts N1, N2, N3, N4 visible in FIGS. 3 and 4 and are indicative of the location and number of holes through the right drive sprocket 22. Similarly, the lug nuts N5, N6, N7, N8 mentioned above and visible in FIGS. 1 and 5 are indicative of the location and number of holes through the hub 54 of the left drive sprocket 52

Since many makes and models of zero-turn mowers (M) have wheel studs of standard sizes and arrangements, the plurality of openings of the sprocket hubs 24, 54 of each of the drive sprockets 22, 52 are provided in similar number and arrangement, which allows the track assemblies 20, 52 to be uniformly mountable on several makes and models of zero-turn lawn mowers (M). Of course, it should be recognized that the size and arrangement of openings through the hubs 24, 54 of the drive sprockets 22, 52 may be modified to match those of the wheel studs provided on the drive axles of other makes and models of zero-turn lawn mowers (M) (or of other types of off-road vehicles) to enable attachment and use of the track system 10 with such other mowers (M).

With reference still to FIGS. 1-5, each of the right and left rear track assemblies 20, 50, further includes a continuous track 40, 70 each of which is disposed around and in contact with both of the corresponding drive sprocket 22, 52 and rear facing idler / tensioner roller 30, 60, respectively. It is contemplated that each of the continuous tracks 40, 70 may suitably have a width of from about 9 in. to about 14 in, such as from about 10 in. to about 12 in., such as about 11 in.. Within a given track system 10, the widths of the right and left continuous tracks 40, 70 should be approximately the same (i.e., within +/- 0.5 inch),

The material of construction for the continuous tracks 40, 70 is not particularly limited, but as determinable by persons of ordinary skill, the continuous tracks 40, 70 should withstand use on a zero-turn lawn mower (M) for at least 6 months to a year before requiring replacement or repair to ensure effective functioning, in the absence of an accident of particularly difficult and uneven terrain. Materials of construction generally include, but are not limited to, one or more of rubber, elastomers, metal, alloys, and similar materials able to withstand outdoor conditions. The continuous tracks 40,70 may, for example without limitation be made of rubber, and may further include continuous steel belts and steel drive cogs/lugs encased in rubber for durability, weight reduction compared to steel, and lack of weak points prone to breaking or wearing out.

Additionally, although shown in the figures as relatively continuous strips formed into closed belts, the continuous tracks 40, 70 may have other physical configurations and designs including, without limitation, sections, plates, pieces, chains, chain mail, etc., of similar dimensions which are connected together with hinged attachments to form the continuous belt shape which may be extended around the drive sprocket 22, 62 and its associated idler / tensioner roller 30, 60, respectively.

As seen most clearly in FIGS. 3, 4 and 5, each continuous track 40, 70 has an inner surface 42, 72 facing its corresponding drive sprocket 22, 52, and having a plurality of protruding mating features (e.g., treads, ridges, bumps, etc.) 44a, 44b, 44c and 74a, 74b, 74c, respectively, which are sized and arranged for mating with a plurality of radially extending projections 28a, 28b, 28c and 58, 58b, 58c of each corresponding drive sprocket 22, 52 during operation of the mower (M) and track system 10. This arrangement of components imparts movement from each drive sprocket 22, 52 to its respective continuous track 40, 70. The plurality of protruding mating features 44a, 44b, 44c and 74a, 74b, 74c on the inner surface 42, 72 of each continuous tread 40, 70, respectively, may comprise one or more different types of such features, including but not limited to treads, ridges, bumps, and the like.

Furthermore, each continuous tread 40, 70 has and an outer surface 46, 76, opposite its inner surface 42, 72, for engaging the terrain (ground) and having a plurality of traction features 48a, 48b, 48c and 78a, 78b, 78c (e.g., raised treads, ridges, bumps, etc.) distributed thereon which contact the terrain (ground) and provide increased traction and stability during operation of the mower (M). The plurality of traction features 48a, 48b, 48c and 78a, 78b, 78c on the outer surface 46, 76, of each continuous tread 40, 70, respectively, may comprise one or more different types of such features, including but not limited to treads, ridges, bumps, and the like. It should be further understood that, while the protruding mating features 44a, 44b, 44c, 74a, 74b, 74c and the traction features 48a, 48b, 48c 78a, 78b, 78c of the continuous tracks 40, 70, respectively, may be of the same type and quantity, this is not a requirement and, instead, they may comprise different types as well as different quantities (and independently of the types). It should be understood that the types and dimensions of the traction features 48a, 48b, 48c 78a, 78b, 78c of the continuous tracks 40, 70, respectively, which are selected will vary, depending on user preference and often based on intended ground or terrain conditions in which the mower (M) having the track system 10 installed thereon will be used.

With reference briefly to FIGS. 3, 7 and 8, as previously mentioned, each of the right and left rear track assemblies 20, 50 is attached to a respective one of the right and left torsion axle assemblies 32, 62, each of which is, in turn, attached to a respective on or the right and left travelling sub-frame unit 16, 18. In should be noted that, instead of connecting the entire track system 10 and its rear track assemblies 20, 50 to a suspension torsion system, as in some conventional track systems and assemblies, the presently described and contemplated track system 10 includes the intermediate right and left torsion axle assemblies 32, 62 for indirect attachment of the track assemblies 20, 50 to the is operably attached, by its respective swing arm 34, 64, to a corresponding one of the right and left idler / tensioner rollers 30, 60 of the right and left rear track assemblies 20, 50, respectively, of presently described track system 10. In turn, each of the torsion axle assemblies 32, 62 is attached, by its respective torsion box 36, 66, with limited right and left reciprocal movement, to a respective one of the right or left traveling sub-frame unit 16, 18 of the track system 10.

More specifically, each torsion axle assembly 32, 62 is in operable contact with its respective idler / tensioner roller 30, 60 and also with a corresponding right or left traveling sub-frame unit 16, 18 of the track system 10, for applying and releasing tension on their respective continuous tracks 40, 70. As explained in further detail below, the suspension torsion axles 32, 62 are affixed to the respective traveling sub-frame units 16, 18 with a configuration which allows each of the suspension torsion axles 32, 62 to travel, independently of one another, forwards and backwards, relative to the traveling sub-frame units 16, 18, respectively, and main frame 14, which applies and releases tension, independently, on the corresponding continuous track 40, 70 of the right and left rear track assemblies 20, 50, respectively. The torsion axle 32, 62 is generally present and common to all embodiments of the track assemblies 20, 50, although the configuration (size and shape) may be varied sufficiently for allowing adjustments to the angle at which the torsion axle 32, 62 of each track assembly 40, 70, respectively, extends downward from the traveling sub-frame 16, 18 of the track system 10.

With reference to FIG. 8, the right torsion axle assembly 32 has a plurality of elongated or slotted holes (oriented left to right), 3 of which are visible 31a, 31b, 31c, by which it is affixed to the right traveling sub-frame 16 using a plurality of corresponding bolts, 3 of which 33a, 33b, 33c are also visible in FIG. 8. The slotted holes 31a., 31b, 31c allow limited left-and-right movement (see arrow B) of the torsion axle assembly 32 as needed to align the corresponding idler/tensioner roller 30 (attached at the other end of the torsion axle assembly 32), with the drive sprocket 22 so that the continuous track 40 will during operation, ride centered on each of the drive sprocket 22 and idler / tensioner roller 60, and not offset therefrom.

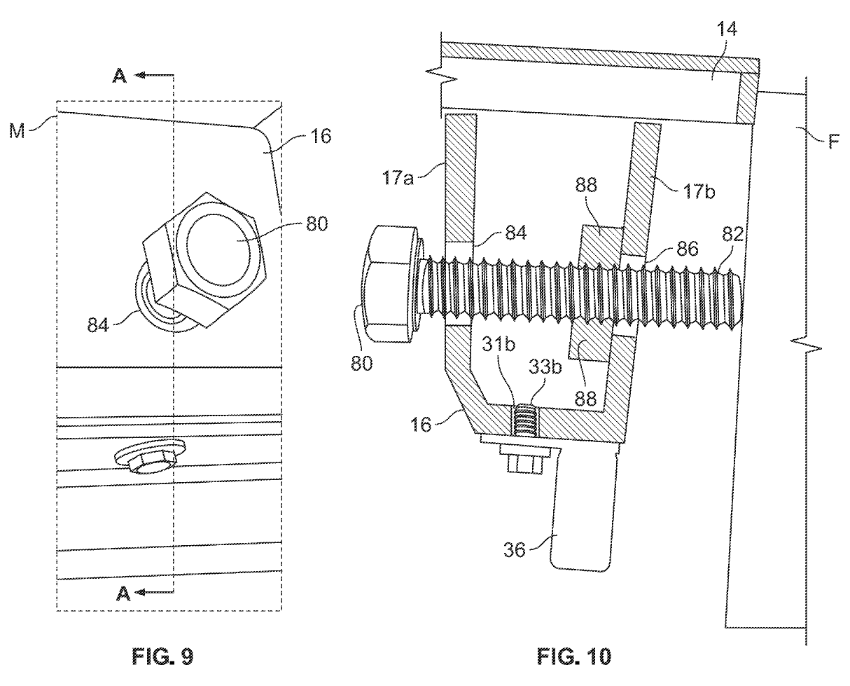

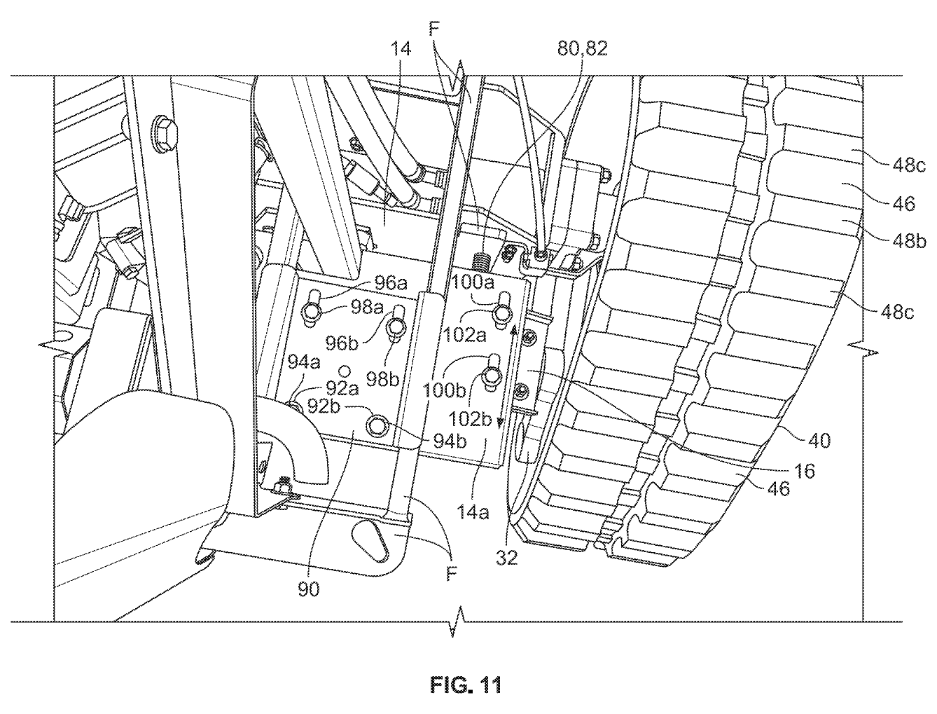

The track system 10 also comprises a positional adjustment mechanism which will now be described with reference particularly to FIGS. 9 and 10. An enlarged version of the portion of the track system 10 enclosed in the dotted box J in FIG. 8 is provided in FIG. 9. FIG. In turn, 10 provides a schematic cross-sectional view of the portion of the track system 10 shown in FIG. 9, taken along line A-A and looking in the direction of the arrows. Generally, a jack bolt 80 having a threaded end 82 is inserted through aligned holes 84, 86 provided in front and rear walls 17a, 17b of the right traveling sub-frame 16, with the threaded end 82 in contact with the mower frame (M). Additionally, an internally threaded nut 88 is welded to the inner surface of the rear wall 17b of the right traveling sub-frame 16, concentrically positioned with the hole in the rear wall 17b for receiving the jack bolt 80 screwed therethrough.

The jack bolt 80 is operated by turning or rotating it to adjust tension on the right rear track assembly 20 by moving the right traveling sub-frame 16 forwards and backwards relative to the mower frame (F). More specifically, turning the jack bolt 80 to the right (clockwise) engages the welded nut 88 and moves the right traveling sub-frame 16 backward and further from the mower frame (F), which increases tension on the right track assembly 20. Turning the jack bolt 80 to the left (counterclockwise) engages the welded nut 88 and moves the right traveling sub-frame 16 forward and closer to the mower frame (F), which decreases tension on the right track assembly 20.

With reference briefly to FIG. 11, the track system 10 further includes at least two clamps 90 for securely affixing the track system 10, at the right and left sides 14a, 14b of the main frame 14, to the mower frame (F). Only the right clamp 90 is visible in the FIG. 11, but it should be understood that a mirror image left clamp is provided at the left side 14a of the main frame 14b and has features analogous to those of the right clamp 90 and operates in the same manner as the right clamp 90. Accordingly, the features and operation of only the right clamp 90 will be described in detail below.

The right clamp 90 has at least two holes 92a, 92b, therethrough, each of which is aligned with a corresponding hole (not shown) provided through the right side 14b of the main frame 14 of the track system 10, for receiving a corresponding bolt 94a, 94b (each secured with a nut) therethrough and securely attaching the main frame 14 to the mower frame (F). This arrangement securely attaches the main frame 14 and track system 10 to the mower (M).

Additionally, at least two slotted holes 96a, 96b, both oriented front to rear, are provided through the right clamp 90, and each slotted hole 96a, 96b is aligned with corresponding holes (not shown and not slotted) through the main frame 14, at its right side 14a, and the right traveling sub-frame 16, for receiving a corresponding bolt 98a, 98b therethrough and fastened with a nut. This arrangement attaches the both the main frame 14 and right traveling sub-frame 16 of the suspension assembly to the mower frame (F) of the mower (M), while allowing limited front to rear movement of the main frame 14 and right traveling sub-frame 16 together relative to the mower frame (F).

FIG. 11 also shows an attachment between the main frame 14 (right side 14a) and the right traveling sub-frame 16 which also allows limited front to rear movement of the right traveling sub-frame 16 relative to the main frame 14. This attachment is formed by at least two slotted holes 100a, 100b, both oriented front to rear, provided through the right side 14a of the main frame, each of which is aligned with corresponding holes (not shown and not slotted) through the right traveling sub-frame 16, with a corresponding bolt 102a, 102b received, though each pair of aligned holes 100a, 100b, and each fastened with a nut.

Although the invention has been described in connection with specific embodiments, as previously discussed, it should be understood that the invention as claimed should not be unduly limited to such specific embodiments. Indeed, various modifications and variations of the subject matter described above will be apparent to those of ordinary skill in the relevant art and are within the scope of the present disclosure.

1. A track system for attachment and use with an off-road vehicle and which provides increased traction with terrain on which the vehicle is operated, wherein the vehicle has a vehicle frame, a right rear drive axle, and left rear drive axle, the track system comprising:
a right rear track assembly and a left rear track assembly, each comprising:
a single drive sprocket,
a single idler / tensioner roller which is positioned at the rear of and being in contact with its corresponding drive sprocket,
a continuous track which is disposed around and in contact with both of the corresponding single drive sprocket and the corresponding single idler / tensioner roller,
wherein the drive sprocket of the right rear track assembly is configured for rotatably mounting to the right rear drive axle of the vehicle and moves the continuous track of the right rear track assembly when rotated by operation of the right rear drive axle, and the drive sprocket of the left rear track assembly is configured for rotatably mounting to the left rear drive axle of the vehicle and moves the continuous track of the left rear track assembly when rotated by operation of the left rear drive axle,
and
a suspension frame assembly configured to allow limited movement of the track assembly relative to the vehicle frame and provide torsion adjustments to each of the single idler / tensioner rollers of the right and left rear track assemblies, the suspension frame assembly comprising:
a main frame having a right side and a left side and configured to affix the track system to the mower frame, and
a traveling sub-frame which is configured to be movably affixed to the main frame and capable of limited forward and backward reciprocal movement relative to the main frame and the vehicle frame;
a right torsion axle assembly movably affixed to the traveling sub-frame, at a right side thereof, and capable of limited right and left reciprocal movement relative to the traveling sub-frame, and operably connected to the idler / tensioner roller of the right rear track assembly for applying and releasing torsion on the idler / tensioner roller and on the continuous track of the right rear track assembly during operation of the vehicle, and
a left torsion axle assembly movably affixed to the traveling sub-frame, at a left side thereof, and capable of limited right and left reciprocal movement relative to the traveling sub-frame, and operably connected to the idler / tensioner roller of the left track assembly for applying and releasing torsion on the idler / tensioner roller and on the left rear track assembly during operation of the vehicle.

2. A track system of claim 1, wherein the traveling sub-frame comprises: a right traveling sub-frame unit moveably affixed to a right side of the main frame and the right torsion axle assembly being movably affixed thereto, and a left traveling sub-frame unit moveably affixed to a left side of the main frame and the left torsion axle assembly being movably affixed thereto.

3. A track system of claim 1, wherein each of the right torsion axle assembly and the left torsion axle assembly includes a swing arm and a torsion box pivotably connected to the swing arm and having two or more left to right oriented slotted holes, wherein the right torsion axle assembly is movably attached by its torsion box to a right side of the traveling sub-frame using the two or more left to right oriented slotted holes, and the left torsion axle assembly is movably attached by its torsion box to a left side of the traveling sub-frame using the two or more left to right oriented slotted holes.

4. The track system of claim 1, wherein the traveling sub-frame is movably affixed to the main frame and capable of limited frontward and backward movement by at least a first movable connection and a second movable connection, wherein the first movable connection is formed by two or more front to rear oriented slotted holes provided on the right side of the main frame and two or more non-slotted holes provided on the right side of the traveling sub-frame, wherein each of the slotted holes is aligned with a corresponding one of the two or more non-slotted holes on the right side of the traveling sub-frame unit and has a respective bolt inserted therethrough and secured with a nut, and
the second movable connection is formed by two or more front to rear oriented slotted holes provided on the left side of the main frame and two or more non-slotted holes provided on the left side of the traveling sub-frame unit, wherein each of the slotted holes is aligned with a corresponding one of the two or more non-slotted holes on the left side of the traveling sub-frame unit and has a respective bolt inserted therethrough and secured with a nut.

5. The track system of claim 1, wherein the main frame and the traveling sub-frame of the suspension assembly are movably affixed to the vehicle frame and wherein the main frame and the traveling sub-frame are capable of limited front to rear movement together, relative to the vehicle frame.

6. The track system of claim 1, further comprising at least a right clamp and a left clamp for affixing the track system to the vehicle frame and allowing limited forward and backward movement of the main frame and the traveling sub-frame together, relative to the vehicle frame, wherein the right clamp has at least two holes, each of which is aligned with a corresponding one of at least two holes provided through the right side of the main frame and a corresponding bolt is inserted through each set of aligned holes and secured by a corresponding nut, whereby the main frame is securely affixed to the mower frame, and
wherein at least two front to rear slotted holes are provided through the right clamp and each slotted hole is aligned with a corresponding one of at least two non-slotted holes provided on the right side of the main frame and also aligned with a corresponding one of at least two non-slotted holes provided on the right side of the traveling sub-frame, and a corresponding bolt is inserted through each set of aligned holes and secured by a corresponding nut, whereby both the main frame and traveling sub-frame are movably affixed to the mower frame and capable of limited front to rear movement together relative to the mower frame.

7. A track system of claim 1, wherein each continuous track has an inner surface facing and in contact with its corresponding single drive sprocket, and an outer surface opposite the inner surface for engaging terrain on which the vehicle is operated.

8. A track system of claim 7, wherein each drive sprocket of each of the right and left rear track assemblies has a plurality of radially extending features, and
wherein the inner surface of each continuous track of each of the right and left rear track assemblies has a plurality of raised mating features disposed and spaced thereon for mating and engaging with the plurality of radially extending features of the corresponding drive sprocket for assisting with movement of the continuous track by the drive sprocket when rotating.

9. A track system of claim 1, wherein each drive sprocket is mountable on a respective one of the right rear drive axle and the left rear drive axle of the vehicle using wheel studs and lug nuts provided with each respective one of the right and left rear drive axles.

10. A vehicle comprising the track system of claim 1.

11. The vehicle of claim 10, wherein the vehicle is a zero-turn lawn mower.

12. The vehicle of claim 11, wherein the zero-turn lawn mower is a consumer scale zero-turn lawn mower.

13. The vehicle of claim 10, wherein the vehicle is an all-terrain vehicle (ATV).

14. The vehicle of claim 10, wherein the vehicle is a snowmobile and comprises at least one ski operably mounted to a front part of the snowmobile.
